(19) United States
(12) Patent Application Publication
(10) Pub. No.: US 2026/0148540 A1
(43) Pub. Date: May 28, 2026

(54) APPARATUS AND METHOD FOR REDUCING THE IMPACT OF LABEL NOISE ON THE PREDICTION ACCURACY OF A CONCEPTUAL BOTTLENECK MODEL

(71) Applicant: POSTECH RESEARCH AND BUSINESS DEVELOPMENT FOUNDATION, Pohang-si (KR)

(72) Inventors: Nam Hoon LEE, Pohang-si (KR); Seong Hwan PARK, Pohang-si (KR); Ju Eun MOON, Pohang-si (KR)

(21) Appl. No.: 18/963,991

(22) Filed: Nov. 29, 2024

(30) Foreign Application Priority Data
Nov. 28, 2024 (KR) 10-2024-0174092

(51) Int. Cl. G06V 10/82; G06V 10/77; G06V 10/771; G06V 10/776

(52) U.S. Cl. CPC G06V 10/82; G06V 10/771; G06V 10/7715; G06V 10/776

(57) ABSTRACT

A memory in which a training program for identifying concepts that degrade the performance of a concept bottleneck model and training the concept bottleneck model is stored; and a processor configured to execute the training program, wherein the training program: receives a training image set, trains a first concept bottleneck model to infer at least one class using the training image set, trains a second concept bottleneck model by applying a predetermined ratio of noise to the training image set, evaluates the first concept bottleneck model and the second concept bottleneck model using a test image set, and selects concepts that degrade the prediction accuracy of the concept bottleneck model for a specific class using weight information for each concept included in the evaluation results, and wherein the training image set includes: a target label representing a specific class and a concept label corresponding to the target label.

### TECHNICAL FIELD

The present disclosure relates to an apparatus and method for reducing the impact of label noise on the prediction accuracy of a concept bottleneck model. More specifically, the present disclosure relates to an apparatus and method for identifying concept label noise that degrades the prediction accuracy of a concept bottleneck model and training the concept bottleneck model by reflecting the identified noise to reduce the impact of label noise on the prediction accuracy of the concept bottleneck model.

### BACKGROUND

The content described in this section is merely background information regarding the embodiments and does not constitute prior art.

Recently, advancements in deep learning have achieved significant progress across various application fields. However, neural network models are still regarded as black boxes, and interpreting and controlling their decision-making processes remains a challenging issue.

To address these issues, Concept Bottleneck Models (CBMs) have been proposed. Concept Bottleneck Models introduce an intermediate step that connects inputs and final target predictions through human-interpretable concepts, making them a promising solution for enhancing the interpretability of models. For example, instead of relying solely on raw pixel data, a concept bottleneck model classifies the species of an animal based on interpretable concepts such as tail shape or body color, thereby providing a more transparent and comprehensible decision-making process.

Although concept bottleneck models show great potential, they also present the following critical issue. The need for labeled target and concept data during the training process requires extensive additional concept annotations. This annotation process is susceptible to errors, which may result from subjective interpretations of concepts, differences in annotators'expertise, or simple human mistakes, leading to mislabeled data. These issues make concept bottleneck models particularly vulnerable to noisy labels, potentially compromising their reliability.

Consequently, the interpretability, which is the fundamental basis of concept bottleneck models, may be undermined. This can lead to instability in target predictions and raise serious concerns regarding the practicality and reliability of concept bottleneck models.

Accordingly, there is a need for a technology that provides insights into the impact of specific label noise on the performance and interpretability of concept bottleneck models.

### SUMMARY

### Various Objects

An object of the present disclosure is to provide an apparatus and method for training a concept bottleneck model by adding noise to a predetermined concept and extracting noisy labels that affect the prediction accuracy of the concept bottleneck model for a predetermined class.

Another object of the present disclosure is to provide an apparatus and method for training a concept bottleneck model using the extracted noisy labels that affect the prediction accuracy of the concept bottleneck model and the SAM optimization algorithm.

The objects of the present disclosure are not limited to the purposes mentioned above. Other objects and advantages of the present disclosure that are not explicitly mentioned can be understood from the following description and will become more apparent through embodiments of the present disclosure. Furthermore, it will be readily understood that the objects and advantages of the present disclosure can be achieved through the means and combinations set forth in the claims.

### Various Aspects

According to some aspects of the disclosure, A concept bottleneck model training apparatus comprises: a memory in which a training program for identifying concepts that degrade the performance of a concept bottleneck model and training the concept bottleneck model is stored, and a processor configured to execute the training program, wherein the training program: receives a training image set, trains a first concept bottleneck model to infer at least one class using the training image set, trains a second concept bottleneck model by applying a predetermined ratio of noise to the training image set, evaluates the first concept bottleneck model and the second concept bottleneck model using a test image set, and selects concepts that degrade the prediction accuracy of the concept bottleneck model for a specific class using weight information for each concept included in the evaluation results, and wherein the training image set includes: a target label representing a specific class and a concept label corresponding to the target label.

According to some aspects, the training program trains the concept bottleneck model using the concepts that degrade the prediction accuracy for each class and the Sharpness-Aware Minimization (SAM) optimization algorithm.

According to some aspects, the target label includes target information for any one of a plurality of classes, and the concept label includes a plurality of concept information corresponding to a specific class.

According to some aspects, the training program: inputs the test image set into the first concept bottleneck model, calculates the prediction accuracy of the first concept bottleneck model for each class included in the test image set, and generates a first weight list for each class, and wherein the first weight list includes: the plurality of concepts inferred by the first concept bottleneck model for the test images and the weights assigned to each concept when predicting the test images as a specific class.

According to some aspects, the training program extracts the top n concepts with the highest weights from the first weight list for each class to generate a first key concept list for each class.

According to some aspects, the training program generates a noisy image set by applying a predetermined ratio of noise to the concept labels defined in the training image set and trains the second concept bottleneck model using the noisy image set.

According to some aspects, the training program: inputs the test image set into the second concept bottleneck model, calculates the concept accuracy and prediction accuracy of the second concept bottleneck model for each class included in the test image set, and generates a second weight list for each class, and wherein the second weight list includes: the plurality of concepts inferred by the second concept bottleneck model for the test images and the weights assigned to each concept when predicting the test images as a specific class.

According to some aspects, the training program extracts the top n concepts with the highest weights from the second weight list for each class to generate a second key concept list for each class.

According to some aspects, the training program analyzes the impact caused by the concepts corresponding to the noise based on changes in at least one of the prediction accuracy of the second concept bottleneck model, the second weight list, or the second key concept list, relative to the prediction accuracy, the first weight list, and the first key concept list of the first concept bottleneck model.

According to some aspects, the training program analyzes concept accuracy change information for each concept, weight change information for each concept, and prediction accuracy change information for each class caused by the concepts corresponding to the noise, based on changes in the key concepts between the first key concept list and the second key concept list, and identifies the concepts that degrade the prediction accuracy for each class using at least one of the analyzed information.

According to some aspects of the disclosure, a method for training a concept bottleneck model using a concept bottleneck model training apparatus, comprises: receiving a training image set, training a first concept bottleneck model using the training image set, evaluating the first concept bottleneck model using a test image set, training a second concept bottleneck model by applying a predetermined ratio of noise to the training image set, evaluating the second concept bottleneck model using the test image set, and identifying concepts that degrade the prediction accuracy of the concept bottleneck model using the weight information for each concept included in the evaluation results of the first and second concept bottleneck models, wherein the training image set includes a target label representing a specific class and a concept label corresponding to the target label.

According to some aspects, training the concept bottleneck model using the concepts that degrade the prediction accuracy of the concept bottleneck model for each class and the Sharpness-Aware Minimization (SAM) optimization algorithm.

According to some aspects, the target label includes target information for any one of a plurality of classes, and the concept label includes a plurality of concept information corresponding to a specific class.

According to some aspects, the step of evaluating the first concept bottleneck model includes: inputting the test image set into the first concept bottleneck model, calculating the prediction accuracy of the first concept bottleneck model for each class included in the test image set, and generating a first weight list for each class, and wherein the first weight list includes: the plurality of concepts inferred by the first concept bottleneck model for the test images and the weights assigned to each concept when predicting the test images as a specific class.

According to some aspects, the evaluating the first concept bottleneck model includes: extracting the top n concepts with the highest weights from the first weight list for each class to generate a first key concept list for each class.

According to some aspects, the training the second concept bottleneck model includes: generating a noisy image set by applying a predetermined ratio of noise to the concept labels defined in the training image set and training the second concept bottleneck model using the noisy image set.

According to some aspects, the evaluating the second concept bottleneck model includes: inputting the test image set into the second concept bottleneck model, calculating the concept accuracy and prediction accuracy of the second concept bottleneck model for each class included in the test image set, and generating a second weight list for each class, and wherein the second weight list includes: the plurality of concepts inferred by the second concept bottleneck model for the test images and the weights assigned to each concept when predicting the test images as a specific class.

According to some aspects, the step of evaluating the second concept bottleneck model includes: extracting the top n concepts with the highest weights from the second weight list for each class to generate a second key concept list for each class.

According to some aspects, the identifying the concepts that degrade the prediction accuracy of the concept bottleneck model includes: analyzing the impact caused by the concepts corresponding to the noise based on changes in at least one of the prediction accuracy, the second weight list, or the second key concept list of the second concept bottleneck model relative to the prediction accuracy, the first weight list, and the first key concept list of the first concept bottleneck model.

According to some aspects, the identifying the concepts that degrade the prediction accuracy of the concept bottleneck model includes: analyzing concept accuracy change information for each concept, weight change information for each concept, and prediction accuracy change information for each class caused by the concepts corresponding to the noise, based on changes in the key concepts between the first key concept list and the second key concept list, and identifying the concepts that degrade the prediction accuracy for each class using at least one of the analyzed information.

### Various Effects

The apparatus and method for training a concept bottleneck model according to the present disclosure identify concepts that degrade the prediction accuracy of the concept bottleneck model for a predetermined class and utilize them for training, thereby improving the robustness, interpretability, and prediction accuracy of the concept bottleneck model.

In addition to the aforementioned content, the specific effects of the present disclosure are described along with detailed information for implementing the invention below.

### BRIEF DESCRIPTION OF THE DRAWINGS

FIG. 1 is a block diagram schematically illustrating the configuration of the apparatus for training a concept bottleneck model according to an embodiment of the present disclosure.

FIG. 2 is a block diagram schematically illustrating the configuration of a concept bottleneck model.

FIGS. 3 to 5 are exemplary diagrams illustrating changes in concept weights according to noise for a predetermined class.

FIG. 6 is a flowchart illustrating a method for training a concept bottleneck model according to an embodiment of the present disclosure.

### DETAILED DESCRIPTION OF THE PREFERRED EMBODIMENTS

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

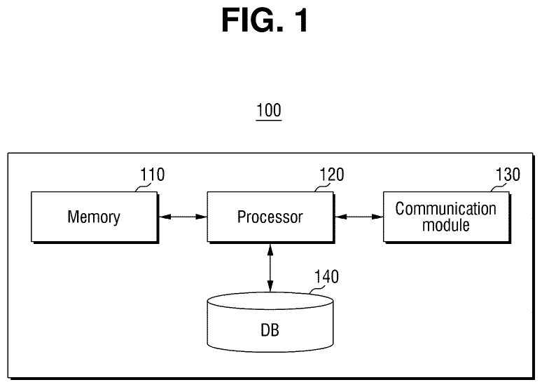

Hereinafter, with reference to FIGS. 1 to 6, the apparatus and method for training a concept bottleneck model according to the embodiments of the present disclosure will be described in detail.

First, with reference to FIGS. 1 to 5, the apparatus for training a concept bottleneck model will be described.

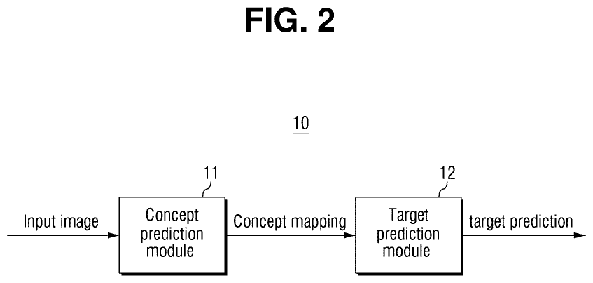

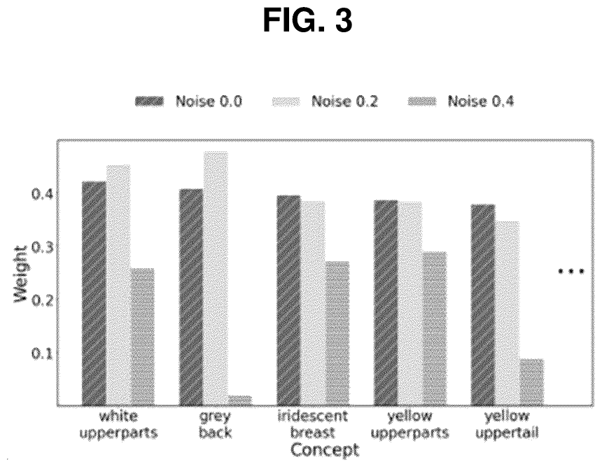

FIG. 1 is a block diagram schematically illustrating the configuration of the apparatus for training a concept bottleneck model according to an embodiment of the present disclosure. FIG. 2 is a block diagram schematically illustrating the configuration of a concept bottleneck model. FIGS. 3 to 5 are exemplary diagrams illustrating changes in concept weights according to noise for a predetermined class.

Referring to FIG. 1, the concept bottleneck model training apparatus 100 receives a training image set and generates a noisy image set by applying a predetermined ratio of noise to the concepts defined in the training image set. The apparatus trains a first concept bottleneck model to infer at least one class using the training image set and trains a second concept bottleneck model using the noisy image set.

In this case, the training dataset may include target labels and concept labels corresponding to the target labels. The target labels may represent each class, and the concept labels may include concept information used to distinguish a predetermined class. A concept bottleneck model trained with such a training image set may infer the concepts included in a given image when the image is input and predict the input image as a predetermined class based on the inferred concepts.

Subsequently, the concept bottleneck model training apparatus 100 evaluates the first concept bottleneck model and the second concept bottleneck model using a test image set and determines the impact of noise-added concepts on the concept bottleneck model based on the weight change information of each concept included in the evaluation results. Based on this, the apparatus may identify concepts that degrade the performance of the concept bottleneck model for each class and train the concept bottleneck model using the concepts that reduce the prediction accuracy for each class and the Sharpness-Aware Minimization (SAM) optimization algorithm.

The concept bottleneck model training apparatus 100 trains the concept bottleneck model using the concepts that reduce the prediction accuracy for each class and the Sharpness-Aware Minimization (SAM) optimization algorithm, thereby improving the robustness and prediction accuracy of the concept bottleneck model against noise.

To perform such operations, the concept bottleneck model training apparatus 100 may include a memory 110 and a processor 120.

The memory 110 may store a training program for identifying concepts that degrade the performance of the concept bottleneck model and for training the concept bottleneck model using the identified concepts. The memory 110 may be interpreted as encompassing both non-volatile storage devices that retain stored information even without power and volatile storage devices that require power to maintain the stored information. Additionally, the memory 110 may perform functions such as temporarily or permanently storing data processed by the processor 120. Apart from volatile storage devices that require power to retain stored information, the memory 110 may include non-volatile storage devices such as magnetic storage media or flash storage media; however, the scope of the present disclosure is not limited thereto.

The processor 120 may execute the training program stored in the memory 110 to train the first concept bottleneck model using the training image set, train the second concept bottleneck model by applying noise to the concept labels defined in the training image set, and identify at least one concept that degrades the prediction accuracy of the concept bottleneck model based on the evaluation results of the first and second concept bottleneck models using the test image set.

More specifically, during the process of predicting the test image set, at least one concept that reduces the prediction accuracy of the concept bottleneck model for each class may be identified by comparing the weight change information of each concept between the first concept bottleneck model trained using the training image set and the second concept bottleneck model trained using the training image set with a predetermined ratio of noise applied.

Then, the third concept bottleneck model may be trained by reflecting at least one concept that reduces the prediction accuracy for each class. At this time, the third concept bottleneck model may be the final model output by the concept bottleneck model training apparatus 100.

Subsequently, the operation of the training program will be described in detail.

First, referring to FIG. 2, the concept bottleneck model will be described. The concept bottleneck model 10 may include a concept prediction module 11 and a target prediction module 12. The concept prediction module 11 maps and outputs the concepts included in the input image. The concepts output by the concept prediction module 11 may be based on the concept information included in the concept labels defined in the training image set during the learning process of the concept prediction module 11.

Furthermore, the target prediction module 12 may predict the input image as a predetermined class based on the concepts output by the concept prediction module 11. The target prediction module 12 may assign weights to each concept output by the concept prediction module 11 to predict the image as a predetermined class.

At this time, the concept prediction module 11 may be implemented as a deep learning neural network, and the target prediction module 12 may be implemented as a shallow neural network such as a simple linear model.

The training of the concept bottleneck model 10 may be classified into independent training, sequential training, and simultaneous training. Independent training refers to a method where the concept prediction module 11 and the target prediction module 12 are trained separately and independently. In this method, the target prediction module 12 may be trained using multiple concepts defined in the training image set as inputs.

Sequential training refers to a method where the concept prediction module 11 is trained first, followed by the training of the target prediction module 12. In this case, the output of the concept prediction module 11 may serve as the input to the target prediction module 12. Simultaneous training refers to a method where the concept prediction module 11 and the target prediction module 12 are trained simultaneously using a multi-objective approach.

Subsequently, the operation of the training program for identifying concepts that degrade the prediction accuracy of the concept bottleneck model will be described.

The training program may perform the following operations: training the first concept bottleneck model using the training image set and evaluating it using the test image set; training the second concept bottleneck model using the noisy image set and evaluating it using the test image set; and identifying concepts that degrade the prediction accuracy of the concept bottleneck model by utilizing the weight information of each concept included in the evaluation results of the first and second concept bottleneck models.

First, the training program receives the training image set. The training image set includes a plurality of training images for at least one class, and each training image may be assigned a target label and a concept label corresponding to the target label.

The target label represents class information for the corresponding image, and the concept label may include a plurality of concept information for the corresponding class. In other words, the concept information may be feature information that may be used to classify the image into the corresponding class. For example, an image of a dog may be assigned a target label indicating “dog” and a concept label containing features that distinguish the image as a dog.

Additionally, the training images included in the training image set share the same concept information, and only the concepts corresponding to the class of each training image may be assigned values. For instance, if the concept label includes ten concepts, the concept label for a first training image may be set as (0,1,0,1,0,0,1,0,1,0), where only the concept information relevant to the class corresponding to the first training image is assigned a value of 1.

Next, the operation of training the first concept bottleneck model using the training image set and evaluating it using the test image set will be described.

The training program trains the first concept bottleneck model to classify input images into one of the classes using the training image set. The first concept bottleneck model may predict targets based on the concept information included in the concept labels defined in the training image set.

Explaining the operation of the trained first concept bottleneck model, the concept prediction module may infer a plurality of concepts included in the input image, and the target prediction module assigns weights to each inferred concept to predict the target. That is, the model infers the concepts, which are the features included in the image, and predicts a specific class corresponding to the target associated with those concepts.

At this time, the concepts inferred by the concept prediction module may be based on the concept labels defined in the training image set. For example, when an image corresponding to the first class associated with the previously described first training image is input, the first concept bottleneck model may infer the concepts for the input image as (0,1,0,1,0,0,1,0,1,0) and classify the input image as the first class based on the inferred concepts.

Subsequently, the training program evaluates the first concept bottleneck model using the test image set. During this process, the training program may calculate the concept accuracy for each class, the prediction accuracy for each class of the first concept bottleneck model on the test image set, and generate a first weight list for each class.

Here, the concept accuracy refers to the difference between the concepts inferred by the first concept bottleneck model for the test images and the concept labels defined for the test images. The prediction accuracy refers to the difference between the class predicted by the first concept bottleneck model for the test images and the target labels defined for the test images.

Additionally, the first weight list may include the plurality of concepts inferred by the first concept bottleneck model for the test images and the weights assigned to each concept when predicting the test images as a specific class. The training program may extract the weights assigned to each concept by the target prediction module of the first concept bottleneck model to generate the first weight list.

Additionally, the training program may extract the top n concepts with the highest weights from the first weight list for each class and generate a first key concept list for each class. The first key concept list may represent critical concepts that may improve the prediction accuracy of the first concept bottleneck model when classifying input images into a specific class.

In other words, the first key concept list may indicate which concepts the first concept bottleneck model relatively relies on during the process of predicting the test images as a specific class. At this time, the greater the weight, the more significantly the corresponding concept may be interpreted as affecting the prediction of the specific class.

Since the first concept bottleneck model was trained using a training image set without noise, the concept accuracy, prediction accuracy, first weight list, and first key concept list of the first concept bottleneck model for a specific class may serve as a baseline.

Next, the operation of training the second concept bottleneck model using the noisy image set and generating a second weight list for the second concept bottleneck model using the test image set will be described.

The training program generates the noisy image set by applying a predetermined ratio of noise to the concept labels defined in the training image set and trains the second concept bottleneck model using the noisy image set.

For example, assuming 20% noise is applied to the concept labels, the concept label for the first training image may change from (0,1,0,1,0,0,1,0,1,0) to (1,1,0,1,0,0,1,0,1,1). In this case, 20% of the concepts not corresponding to the class are set to 1 to add noise, as described in this example. However, noise may be added to 20% of all concepts, including both concepts corresponding to the class and those not corresponding to the class. Specifically, concepts set to 1 may be changed to 0, or concepts set to 0 may be changed to 1, thereby adding noise to 20% of all concepts.

The training program may train the second concept bottleneck model using the noisy image set, in which noise is added to the training image set in this manner. At this time, the training program may generate a noisy image set for all possible cases of applying 20% noise and train the second concept bottleneck model using these sets.

Subsequently, the training program evaluates the second concept bottleneck model using the test image set.

The training program may calculate the concept accuracy for each class and the prediction accuracy for each class of the second concept bottleneck model on the test image set and generate a second weight list for each class. Additionally, it may extract the top n concepts with the highest weights from the second weight list and generate a second key concept list.

The second weight list may include the inferred concepts for the test images and the weight information assigned to each concept when the second concept bottleneck model predicts the test images as a specific class. Furthermore, the second key concept list may be used as information to verify whether the key concepts in the first key concept list have changed during the process of predicting a specific class due to the applied noise.

Next, the operation of identifying concepts that degrade the prediction accuracy of the concept bottleneck model using the weight variation information of each concept included in the evaluation results of the first weight list and the second weight list will be described.

The training program may analyze the concept accuracy, prediction accuracy, second weight list, and second key concept list of the second concept bottleneck model based on the concept accuracy, prediction accuracy, first weight list, and first key concept list of the first concept bottleneck model, generate variation information caused by the concepts corresponding to the applied noise, and identify concepts that degrade the prediction accuracy of the concept bottleneck model for each class based on this analysis.

More specifically, the training program compares the first key concept list with the second key concept list to analyze changes in key concepts. If no changes occur in the key concepts, the training program may compare the first weight list with the second weight list to analyze weight variations for each concept. Additionally, it may analyze changes in concept accuracy and prediction accuracy for each class of the first and second concept bottleneck models to determine the impact of the concepts corresponding to the applied noise on the respective class.

For example, if 20% noise is applied and the second key concept list is identical to the first key concept list, the concept bottleneck model training apparatus 100 may determine that the concepts corresponding to the noise have a minimal impact on the degradation of the prediction accuracy of the concept bottleneck model. Additionally, it may provide information about the concepts corresponding to the noise, including changes in concept accuracy, prediction accuracy, and weight variations for each concept caused by the concepts corresponding to the noise.

On the other hand, if changes occur in the key concept items when comparing the first key concept list with the second key concept list, the modified key concepts may be identified as concepts that degrade the prediction accuracy of the concept bottleneck model. Additionally, information about changes in concept accuracy, prediction accuracy, and weight variations for each concept may be provided along with the identified concepts.

For example, if 20% noise is applied and the second key concept list includes key concepts different from those in the first key concept list, the concept bottleneck model training apparatus 100 may identify these concepts as those impacting the degradation of the prediction accuracy of the concept bottleneck model. Furthermore, it may provide information on the identified concepts, including changes in concept accuracy, prediction accuracy, and weight variations caused by the concepts.

At this time, the training program may increase the noise ratio and repeat the above operations until a predetermined number of concepts that impact the degradation of prediction accuracy for each class are identified.

FIGS. 3 to 5 are exemplary diagrams illustrating changes in concept weights due to noise for the Le Conte Sparrow class.

FIG. 3 shows weight variation information for the first key concept list under the influence of noise. Referring to FIG. 3, the key concepts for the Le Conte Sparrow class in the first concept bottleneck model trained with the training image set are “white upperparts,” “grey back,” “iridescent breast,” “yellow upperparts,” and “yellow upper tail.”

In the second concept bottleneck model trained using a noisy image set with 20% noise applied to the training dataset, it may be observed that the weights of “white upperparts,” “grey back,” “iridescent breast,” “yellow upperparts,” and “yellow upper tail” differ from those in the first concept bottleneck model. This may be understood as a change in the weights of the first key concept list due to the added noise. Furthermore, when 40% noise is applied, it may be observed that the weights of the first key concept list are significantly lower compared to those under 0% and 20% noise conditions.

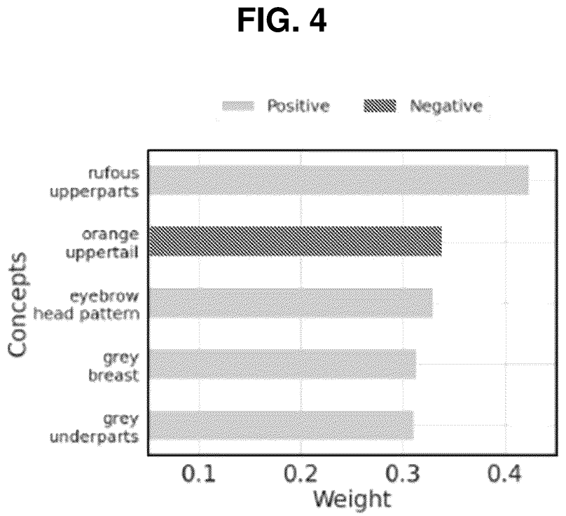

FIG. 4 illustrates the key concepts for the Le Conte Sparrow class in the second concept bottleneck model trained with a training dataset containing 40% noise. Referring to FIG. 4, it may be observed that the key concepts for the Le Conte Sparrow class in the second concept bottleneck model are entirely different from those in the first key concept list.

Among the concepts shown in FIG. 4, it is also evident that some concepts are incorrectly associated with the class. For instance, “orange uppertail,” which corresponds to the Le Conte Sparrow, is recognized as a negative concept, obstructing predictions for the Le Conte Sparrow class. This may be interpreted as having a significant impact on the prediction accuracy of the concept bottleneck model.

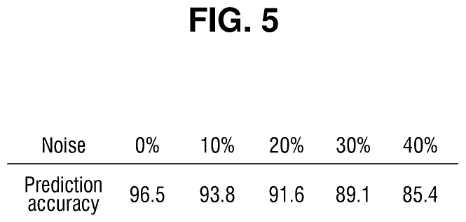

As described above, the training program increases the noise ratio to analyze changes in the first key concept list and may analyze prediction accuracy by noise ratio, as shown in FIG. 5.

Consequently, the training program may identify the concepts depicted in FIG. 4 as those degrading the prediction accuracy of the concept bottleneck model. Additionally, it may provide prediction accuracy change information based on FIG. 5, weight variation information for the first key concept list based on FIG. 3, and concept accuracy change information for each concept.

Subsequently, the training program may train the third concept bottleneck model using the Sharpness-Aware Minimization (SAM) optimization algorithm by reflecting the concepts identified through the above process that degrade the prediction accuracy of the concept bottleneck model for each class.

The third concept bottleneck model may be the final model output by the concept bottleneck model training apparatus 100 of the present disclosure. The third concept bottleneck model is trained using the concepts that degrade the prediction accuracy of the concept bottleneck model for each class and the Sharpness-Aware Minimization (SAM) optimization algorithm, thereby improving robustness and prediction accuracy for input images containing noise.

Meanwhile, the processor 120 may perform hardware control functions such as file system, memory allocation, networking, basic libraries, timers, device control (e.g., display, media, input devices, 3D), and other utilities as required by the program execution. In this embodiment, the processor 120 may be implemented in the form of a microprocessor, central processing unit (CPU), processor core, multiprocessor, application-specific integrated circuit (ASIC), or field-programmable gate array (FPGA), but the scope of the present disclosure is not limited to these forms.

Additionally, the communication module 130 may include a device comprising the hardware and software required to send and receive signals, such as control signals or data signals, through wired or wireless connections with other network devices to perform data communication for signal data with external devices. The database 140 may store various data required for the operation of the training program.

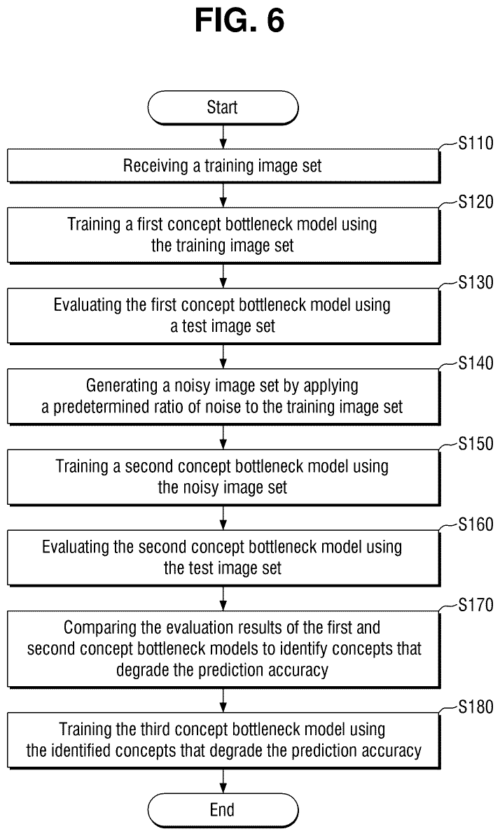

FIG. 6 is a flowchart illustrating a method for training a concept bottleneck model according to an embodiment of the present disclosure.

Referring to FIGS. 1 and 6, the method for training a concept bottleneck model (S100) using the concept bottleneck model training apparatus 100 will be described. The method for training a concept bottleneck model (S100) includes receiving a training image set (step S110); and training a first concept bottleneck model using the training image set (step S120). Then, the first concept bottleneck model is evaluated using a test image set (step S130).

Additionally, a noisy image set is generated by applying a predetermined ratio of noise to the training image set (step S140), and a second concept bottleneck model is trained using the noisy image set (step S150). Then, the second concept bottleneck model is evaluated using the test image set (step S160).

Subsequently, the evaluation results of the first concept bottleneck model and the second concept bottleneck model are compared to identify concepts that degrade the prediction accuracy of the concept bottleneck model (step S170). The third concept bottleneck model is trained using the identified concepts that degrade the prediction accuracy for each class and the Sharpness-Aware Minimization (SAM) optimization algorithm (step S180). At this time, the third concept bottleneck model may be the final model output by the concept bottleneck model training apparatus 100.

The details of each step will now be described.

In step S110, the training image set includes a plurality of training images for at least one class, and each training image may be assigned a target label and a concept label corresponding to the target label. The target label represents class information for the corresponding image, and the concept label may include a plurality of concept information for the corresponding class.

In other words, the concept information may be feature information that allows the image to be classified into the corresponding class. For example, a dog image may be assigned a target label indicating “dog” and a concept label containing features that distinguish the image as a dog.

Additionally, the training images share the same concept information, and only the concepts corresponding to the class of each training image may be assigned values. For instance, if the concept label includes ten concepts, the concept label for the first training image may be set as (0,1,0,1,0,0,1,0,1,0), indicating that only the concept information relevant to the class corresponding to the first training image is assigned a value of 1.

Next, the process of evaluating the first concept bottleneck model using the test image set (step S130) will be described.

First, explaining the operation of the first concept bottleneck model trained using the training image set in step S120, the first concept bottleneck model may predict the class of an input image based on the concept information included in the concept labels defined in the training image set. The first concept bottleneck model may infer a plurality of concepts included in the input image using the concept prediction module, and the target prediction module may assign weights to each inferred concept to predict the target.

In other words, the model may infer the concepts, which are features included in the image, and predict the specific class corresponding to the target associated with those concepts. At this time, the concepts inferred by the concept prediction module may be based on the concept labels defined in the training image set.

For example, when an image corresponding to the first class associated with the previously described first training image is input, the first concept bottleneck model may infer the concepts for the input image as (0,1,0,1,0,0,1,0,1,0) and classify the input image as the first class based on the inferred concepts.

Next, the process of evaluating the performance of the first concept bottleneck model using the test image set (step S130) will be described.

The concept bottleneck model training apparatus 100 may calculate the concept accuracy for each class and the prediction accuracy for each class of the first concept bottleneck model on the test image set and generate a first weight list for each class.

Here, concept accuracy refers to the difference between the concepts inferred by the first concept bottleneck model for the test images and the concept labels defined for the test images. Prediction accuracy refers to the difference between the class predicted by the first concept bottleneck model for the test images and the target labels defined for the test images.

Additionally, the first weight list may include the plurality of concepts inferred by the first concept bottleneck model for the test images and the weights assigned to each concept when predicting the test images as a specific class. The training program can extract the weights assigned to each concept by the target prediction module of the first concept bottleneck model to generate the first weight list.

Furthermore, the concept bottleneck model training apparatus 100 may extract the top n concepts with the highest weights from the first weight list for each class to generate a first key concept list for each class. The first key concept list may represent the most critical concepts for classifying the respective class.

Since the first concept bottleneck model is trained using the training image set without noise, the prediction accuracy, first weight list, and first key concept list of the first concept bottleneck model may be used as baseline values.

For example, when test images of the Le Conte Sparrow class are input, the first concept bottleneck model may extract which concepts are inferred from the test images, the degree of weight assigned to each inferred concept, and how the test images are predicted as belonging to the Le Conte Sparrow class. Using this information, it may generate the first weight list for the Le Conte Sparrow class and extract the top n concepts with the highest weights to create the first key concept list. In other words, the greater the weight, the more significantly the concept may be interpreted as affecting the prediction of the specific class.

Next, the process of generating the noisy image set (step S140) will be described.

The concept bottleneck model training apparatus 100 may generate a noisy image set by applying a predetermined ratio of noise to the concept labels defined in the training image set.

For example, assuming 20% noise is applied to the concept labels, the concept label for the first training image may change from (0,1,0,1,0,0,1,0,1,0) to (1,0,0,1,0,0,1,0,1,0). Noise may be added by setting the concepts corresponding to the class to 0 or setting the concepts not corresponding to the class to 1, thereby applying noise to 20% of the entire concepts. Using the noisy image set generated in this way, the second concept bottleneck model may be trained in step S150.

Next, the process of evaluating the second concept bottleneck model using the test image set (step S160) will be described.

The concept bottleneck model training apparatus 100 may input the test image set into the second concept bottleneck model, calculate the prediction accuracy of the second concept bottleneck model for each class included in the test image set, and generate the second weight list of the second concept bottleneck model.

The second weight list may include the concepts inferred by the second concept bottleneck model for the test images and the weight information assigned to each concept when predicting the test images as a specific class. Additionally, the top n concepts with the highest weights may be extracted from the second weight list to generate the second key concept list. Here, the second key concept list may be used as information to verify whether critical concepts have changed during the process of predicting a specific class due to the applied noise.

Next, the process of identifying concepts that degrade the prediction accuracy of the concept bottleneck model by comparing the evaluation results of the first concept bottleneck model and the second concept bottleneck model (step S170) will be described.

The concept bottleneck model training apparatus 100 may analyze the prediction accuracy, first weight list, and first key concept list of the first concept bottleneck model as a baseline, along with the prediction accuracy, second weight list, and second key concept list of the second concept bottleneck model. It may generate variation information caused by the concepts corresponding to the applied noise and, based on this, identify the concepts that degrade the prediction accuracy of the concept bottleneck model for each class.

More specifically, the concept bottleneck model training apparatus 100 compares the first key concept list with the second key concept list to analyze changes in key concepts. If no changes occur in the key concepts, the apparatus compares the first weight list with the second weight list to analyze the weight variations for each concept. Additionally, it may analyze changes in concept accuracy and prediction accuracy for each class in the first and second concept bottleneck models to determine the impact of the concepts corresponding to the applied noise on the respective class.

For example, if 20% noise is applied and the second key concept list is identical to the first key concept list, the concept bottleneck model training apparatus 100 may determine that the concepts corresponding to the noise have a minimal impact on the degradation of the prediction accuracy of the concept bottleneck model. Additionally, it may provide information about the concepts corresponding to the noise, including changes in concept accuracy, prediction accuracy, and weight variations for each concept caused by the concept corresponding to the noise.

On the other hand, if changes occur in the key concept items when comparing the first key concept list with the second key concept list, the altered key concepts may be identified as concepts that degrade the prediction accuracy of the concept bottleneck model.

For example, if 20% noise is applied and the second key concept list includes key concepts different from those in the first key concept list, the concept bottleneck model training apparatus 100 may identify these concepts as those impacting the degradation of the prediction accuracy of the concept bottleneck model. Additionally, it may provide information about the identified concepts, including changes in concept accuracy, prediction accuracy, and weight variations caused by the concepts.

Referring to FIGS. 3 to 5, the process of identifying concepts that impact the degradation of the prediction accuracy of the concept bottleneck model based on the first key concept list will be described as an example.

As shown in FIG. 3, the key concepts for the Le Conte Sparrow class in the first concept bottleneck model trained using the training image set are “white upperparts,” “grey back,” “iridescent breast,” “yellow upperparts,” and “yellow upper tail.”

When 20% noise is applied to the training dataset, it may be observed that the weights of “white upperparts,” “grey back,” “iridescent breast,” “yellow upperparts,” and “yellow upper tail” in the second concept bottleneck model differ from those in the first concept bottleneck model. This may be understood as a change in the weights of the first key concept list due to the added noise. Furthermore, when 40% noise is applied, it may be observed that the weights of the first key concept list are significantly lower compared to those under 0% and 20% noise conditions.

FIG. 4 illustrates the key concepts for the Le Conte Sparrow class in the second concept bottleneck model trained with a training image set containing 40% noise. Referring to FIG. 4, it may be observed that the key concepts for the Le Conte Sparrow class in the second concept bottleneck model trained with a 40% noisy training image set are entirely different from those in the first key concept list.

Among the concepts shown in FIG. 4, it may also be identified that there are incorrect associations between the concepts and the class. For example, “orange uppertail” is a concept corresponding to the Le Conte Sparrow but is recognized as a negative concept, thereby obstructing predictions for the Le Conte Sparrow class. This may be determined as having a significant impact on the prediction accuracy of the concept bottleneck model.

As described above, the training program increases the noise ratio to analyze changes in the first key concept list and may analyze prediction accuracy based on noise ratios, as shown in FIG. 5.

Subsequently, the concept bottleneck model training apparatus 100 may train the third concept bottleneck model (step S180) using the Sharpness-Aware Minimization (SAM) optimization algorithm by reflecting the concepts identified through the above process that degrade the prediction accuracy of the concept bottleneck model for each class.

The third concept bottleneck model may be the final model output by the concept bottleneck model training apparatus 100 of the present disclosure. The third concept bottleneck model is trained using the concepts that degrade the prediction accuracy of the concept bottleneck model for each class and the Sharpness-Aware Minimization (SAM) optimization algorithm, thereby improving robustness and prediction accuracy for input images containing noise.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

### DESCRIPTION OF REFERENCE NUMERALS

100: Concept bottleneck model training apparatus
110: Memory
120: Processor

1. A concept bottleneck model training apparatus comprising:
a memory in which a training program for identifying concepts that degrade the performance of a concept bottleneck model and training the concept bottleneck model is stored; and
a processor configured to execute the training program,
wherein the training program:
receives a training image set, trains a first concept bottleneck model to infer at least one class using the training image set, trains a second concept bottleneck model by applying a predetermined ratio of noise to the training image set, evaluates the first concept bottleneck model and the second concept bottleneck model using a test image set, and selects concepts that degrade the prediction accuracy of the concept bottleneck model for a specific class using weight information for each concept included in the evaluation results, and
wherein the training image set includes:
a target label representing a specific class and a concept label corresponding to the target label.

2. The concept bottleneck model training apparatus according to claim 1,
wherein the training program trains the concept bottleneck model using the concepts that degrade the prediction accuracy for each class and the Sharpness-Aware Minimization (SAM) optimization algorithm.

3. The concept bottleneck model training apparatus according to claim 1,
wherein the target label includes target information for any one of a plurality of classes, and
the concept label includes a plurality of concept information corresponding to a specific class.

4. The concept bottleneck model training apparatus according to claim 1,
wherein the training program:
inputs the test image set into the first concept bottleneck model, calculates the prediction accuracy of the first concept bottleneck model for each class included in the test image set, and generates a first weight list for each class,
and wherein the first weight list includes:
the plurality of concepts inferred by the first concept bottleneck model for the test images and the weights assigned to each concept when predicting the test images as a specific class.

5. The concept bottleneck model training apparatus according to claim 4,
wherein the training program extracts the top n concepts with the highest weights from the first weight list for each class to generate a first key concept list for each class.

6. The concept bottleneck model training apparatus according to claim 1,
wherein the training program generates a noisy image set by applying a predetermined ratio of noise to the concept labels defined in the training image set and trains the second concept bottleneck model using the noisy image set.

7. The concept bottleneck model training apparatus according to claim 5,
wherein the training program:
inputs the test image set into the second concept bottleneck model, calculates the concept accuracy and prediction accuracy of the second concept bottleneck model for each class included in the test image set, and generates a second weight list for each class,
and wherein the second weight list includes:
the plurality of concepts inferred by the second concept bottleneck model for the test images and the weights assigned to each concept when predicting the test images as a specific class.

8. The concept bottleneck model training apparatus according to claim 7,
wherein the training program extracts the top n concepts with the highest weights from the second weight list for each class to generate a second key concept list for each class.

9. The concept bottleneck model training apparatus according to claim 8,
wherein the training program analyzes the impact caused by the concepts corresponding to the noise based on changes in at least one of the prediction accuracy of the second concept bottleneck model, the second weight list, or the second key concept list, relative to the prediction accuracy, the first weight list, and the first key concept list of the first concept bottleneck model.

10. The concept bottleneck model training apparatus according to claim 9,
wherein the training program analyzes concept accuracy change information for each concept, weight change information for each concept, and prediction accuracy change information for each class caused by the concepts corresponding to the noise, based on changes in the key concepts between the first key concept list and the second key concept list, and identifies the concepts that degrade the prediction accuracy for each class using at least one of the analyzed information.

11. A method for training a concept bottleneck model using a concept bottleneck model training apparatus, comprising:
receiving a training image set;
training a first concept bottleneck model using the training image set;
evaluating the first concept bottleneck model using a test image set;
training a second concept bottleneck model by applying a predetermined ratio of noise to the training image set;
evaluating the second concept bottleneck model using the test image set; and
identifying concepts that degrade the prediction accuracy of the concept bottleneck model using the weight information for each concept included in the evaluation results of the first and second concept bottleneck models,
wherein the training image set includes a target label representing a specific class and a concept label corresponding to the target label.

12. The method for training a concept bottleneck model according to claim 11, further comprising:
training the concept bottleneck model using the concepts that degrade the prediction accuracy of the concept bottleneck model for each class and the Sharpness-Aware Minimization (SAM) optimization algorithm.

13. The method for training a concept bottleneck model according to claim 11,
wherein the target label includes target information for any one of a plurality of classes, and
the concept label includes a plurality of concept information corresponding to a specific class.

14. The method for training a concept bottleneck model according to claim 11,
wherein the step of evaluating the first concept bottleneck model includes:
inputting the test image set into the first concept bottleneck model, calculating the prediction accuracy of the first concept bottleneck model for each class included in the test image set, and generating a first weight list for each class, and
wherein the first weight list includes:
the plurality of concepts inferred by the first concept bottleneck model for the test images and the weights assigned to each concept when predicting the test images as a specific class.

15. The method for training a concept bottleneck model according to claim 14,
wherein the evaluating the first concept bottleneck model includes:
extracting the top n concepts with the highest weights from the first weight list for each class to generate a first key concept list for each class.

16. The method for training a concept bottleneck model according to claim 11,
wherein the training the second concept bottleneck model includes:
generating a noisy image set by applying a predetermined ratio of noise to the concept labels defined in the training image set and training the second concept bottleneck model using the noisy image set.

17. The method for training a concept bottleneck model according to claim 14,
wherein the evaluating the second concept bottleneck model includes:
inputting the test image set into the second concept bottleneck model, calculating the concept accuracy and prediction accuracy of the second concept bottleneck model for each class included in the test image set, and generating a second weight list for each class, and
wherein the second weight list includes:
the plurality of concepts inferred by the second concept bottleneck model for the test images and the weights assigned to each concept when predicting the test images as a specific class.

18. The method for training a concept bottleneck model according to claim 17,
wherein the step of evaluating the second concept bottleneck model includes:
extracting the top n concepts with the highest weights from the second weight list for each class to generate a second key concept list for each class.

19. The method for training a concept bottleneck model according to claim 18,
wherein the identifying the concepts that degrade the prediction accuracy of the concept bottleneck model includes:
analyzing the impact caused by the concepts corresponding to the noise based on changes in at least one of the prediction accuracy, the second weight list, or the second key concept list of the second concept bottleneck model relative to the prediction accuracy, the first weight list, and the first key concept list of the first concept bottleneck model.

20. The method for training a concept bottleneck model according to claim 19,
wherein the identifying the concepts that degrade the prediction accuracy of the concept bottleneck model includes:
analyzing concept accuracy change information for each concept, weight change information for each concept, and prediction accuracy change information for each class caused by the concepts corresponding to the noise, based on changes in the key concepts between the first key concept list and the second key concept list, and identifying the concepts that degrade the prediction accuracy for each class using at least one of the analyzed information.
